(19) United States
(12) Patent Application Publication
(10) Pub. No.: US 2018/0091667 A1
(43) Pub. Date: Mar. 29, 2018

(54) INFORMATION PROCESSING DEVICE, IMAGE FORMING APPARATUS, INFORMATION PROCESSING METHOD AND NON-TRANSITORY COMPUTER READABLE MEDIUM STORING PROGRAM

(71) Applicant: FUJI XEROX CO., LTD., Tokyo (JP)

(72) Inventors: Hideki YAMASAKI, Yokohama-shi (JP); Hiroyuki ISHIKAWA, Yokohama-shi (JP); Yuki YAMANAKA, Yokohama-shi (JP)

(73) Assignee: FUJI XEROX CO., LTD., Tokyo (JP)

(21) Appl. No.: 15/467,359

(22) Filed: Mar. 23, 2017

(30) Foreign Application Priority Data
Sep. 23, 2016 (JP) 2016-185543

(51) Int. Cl. H04N 1/00

(52) U.S. Cl. CPC H04N 1/00472; H04N 1/00381; H04N 2201/0094; H04N 1/00503; H04N 1/00474; H04N 1/00413

(57) ABSTRACT

An information processing device includes: a line of sight detection unit that detects a position of a user's line of sight on a display to display an image; and a display controller that displays a pop-up screen about an item to be displayed on the display and controls a display position of the pop-up screen in response to the position of line of sight detected by the line of sight detection unit.

### CROSS REFERENCE TO RELATED APPLICATIONS

This application is based on and claims priority under 35 USC § 119 from Japanese Patent Application No. 2016-185543 filed Sep. 23, 2016.

### BACKGROUND

### Technical Field

The present invention relates to an information processing device, an image forming apparatus, an information processing method and a non-transitory computer readable medium storing a program.

### Related Art

In a display part of an information processing device, a list of functions related to the device is displayed as an image in some cases. A method that enables a user to select an intended function from the list is used in general. There has conventionally been a technique to display a pop-up screen for explaining each function to the user at that time.

### SUMMARY

According to an aspect of the present invention, there is provided an information processing device including: a line of sight detection unit that detects a position of a user's line of sight on a display to display an image; and a display controller that displays a pop-up screen about an item to be displayed on the display and controls a display position of the pop-up screen in response to the position of line of sight detected by the line of sight detection unit.

### BRIEF DESCRIPTION OF THE DRAWINGS

Exemplary embodiments of the present invention will be described in detail based on the following figures, wherein:

FIG. 1 is an outline view of an image forming apparatus related to exemplary embodiments;

FIG. 2 is a diagram showing an internal configuration of the image forming apparatus related to the exemplary embodiments;

FIG. 3 is a diagram showing an example of an image displayed on a user interface;

FIGS. 4A to 4D are diagrams illustrating methods of detecting a position of a user's line of sight from an image of user's eye taken by a camera;

FIG. 5 is a block diagram showing a functional configuration of a controller;

FIG. 6 is a diagram showing a first example of a screen displaying a pop-up screen by the user interface in a first exemplary embodiment;

FIG. 7 is a diagram showing a second example of the screen displaying the pop-up screen by the user interface in the first exemplary embodiment;

FIG. 8 is a diagram showing a third example of the screen displaying the pop-up screen by the user interface in the first exemplary embodiment;

FIG. 9 is a diagram showing an image forming apparatus to which a second exemplary embodiment is applied;

FIGS. 10A and 10B are diagrams showing screens displaying a pop-up screen in the second exemplary embodiment;

FIG. 11 is a diagram showing an image forming apparatus to which a third exemplary embodiment is applied;

FIGS. 12A and 12B are diagrams showing screens displaying a pop-up screen in the third exemplary embodiment; and

FIG. 13 is a flowchart illustrating operations of the controller.

### DETAILED DESCRIPTION

Hereinafter, the exemplary embodiments will be described in detail with reference to attached drawings.

### <Description of Entire Configuration of Image Forming Apparatus 1>

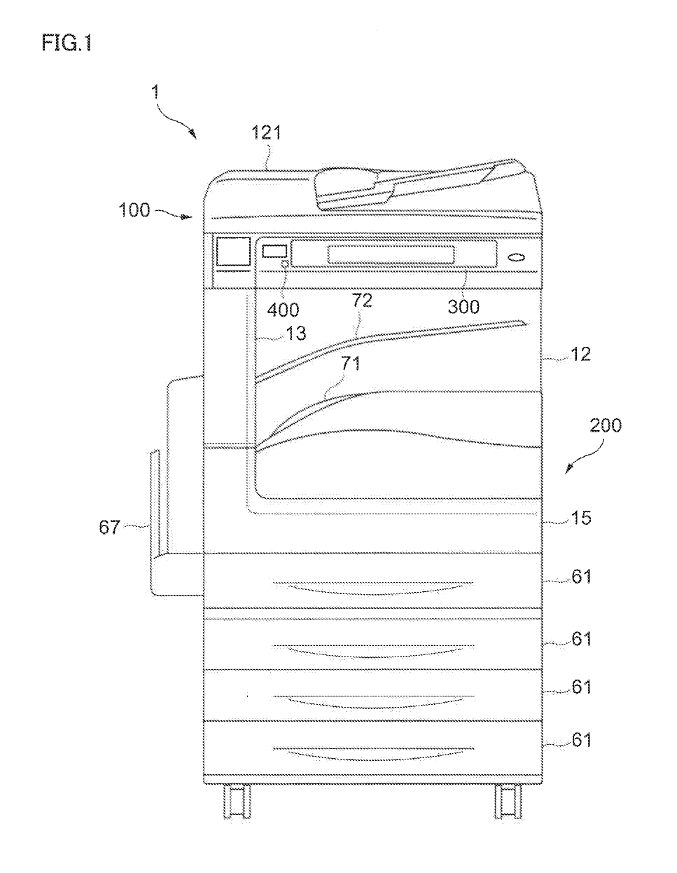

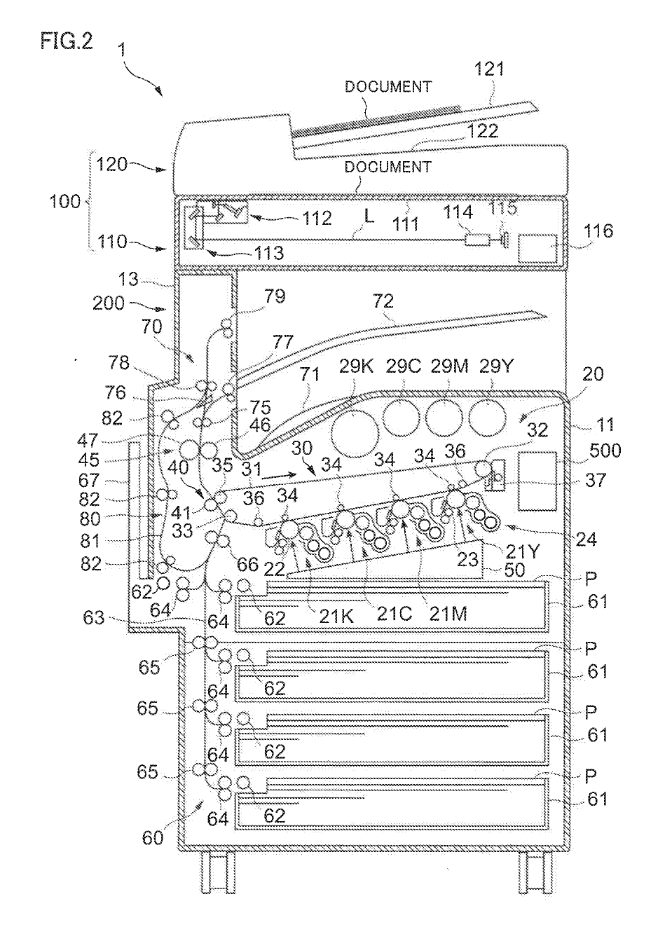

FIG. 1 is an outline view of an image forming apparatus 1 related to the exemplary embodiments. FIG. 2 is a diagram showing an internal configuration of the image forming apparatus 1 related to the exemplary embodiments.

The image forming apparatus 1 includes an image reading device 100 that reads an image of a document and an image recording device 200 that records an image on a recording material (hereinafter, representatively referred to as “sheet” in some cases). Moreover, the image forming apparatus 1 includes a user interface (UI) 300 that accepts an operation input from a user or displays various kinds of information items to a user. The image forming apparatus 1 also includes a camera 400 for detecting a position of a user's line of sight. Further, the image forming apparatus 1 includes a controller 500 that controls operations of the entire image forming apparatus 1.

The image reading device 100 is disposed at an upper portion of the image forming apparatus 1, and the image recording device 200 is disposed below the image reading device 100 and includes the controller 500. The user interface 300 is disposed at a frontward side of the upper portion of the image forming apparatus 1, that is, at a frontward side of an image reading part 110, which will be described later, of the image reading device 100. Moreover, the camera 400 is disposed at a bottom left of the user interface 300.

First, the image reading device 100 will be described.

The image reading device 100 includes the image reading part 110 that reads an image on a document and a document transport part 120 that transports a document to the image reading part 110. The document transport part 120 is disposed at an upper portion of the image reading device 100, and the image reading part 110 is disposed at a lower portion of the image reading device 100.

The document transport part 120 includes a document containing part 121 that contains documents and a document discharge part 122 that discharges documents transported from the document containing part 121, and thereby, the documents are transported from the document containing part 121 to the document discharge part 122. The document transport part 120 is also referred to as an ADF (automatic document feeder).

The image reading part 110 includes a platen glass 111, a light irradiation unit 112 that irradiates a read surface (an image surface) of a document with light, a light guiding unit 113 that guides light L, which has been emitted from the light irradiation unit 112 to the read surface of the document and reflected by the read surface of the document, and an image-forming lens 114 that forms an optical image of the light L guided by the light guiding unit 113. Moreover, the image reading part 110 includes a detection part 115 that is configured with a photoelectric conversion element, such as a CCD (charge coupled device) image sensor, for performing photoelectric conversion of the light L, with which an image has been formed by the image-forming lens 114, to thereby detect the formed optical image, and an image processing part 116 that is electrically connected to the detection part 115 to receive an electric signal as image information obtained by the detection part 115.

The image reading part 110 reads an image on a document transported by the document transport part 120 or an image on a document placed on the platen glass 111.

Next, the image recording device 200 will be described.

The image recording device 200 includes an image forming part 20 that forms an image on a sheet P, a sheet supply part 60 that supplies a sheet P to the image forming part 20, a sheet output part 70 that outputs a sheet P, on which an image has been formed by the image forming part 20, and a reverse transport part 80 that reverses a sheet upside down, on one side of which an image has been formed by the image forming part 20, and transports the sheet again toward the image forming part 20.

The image forming part 20 includes four image forming units 21Y, 21M, 21C and 21K disposed in parallel at regular intervals for forming images of yellow (Y), magenta (M), cyan (C) and black (K), respectively. Each of the image forming units 21Y, 21M, 21C and 21K includes a photoconductive drum 22, a charger 23 that uniformly charges a surface of the photoconductive drum 22, and a developer 24 that develops an electrostatic latent image that has been formed by laser irradiation by an optical unit 50, which will be described later, with toner of a predetermined color component and visualizes thereof. Moreover, the image forming part 20 is provided with toner cartridges 29Y, 29M, 29C and 29K for supplying toner of respective colors to the developers 24 of the image forming units 21Y, 21M, 21C and 21K.

The image forming part 20 includes, below the image forming units 21Y, 21M, 21C and 21K, the optical unit 50 that irradiates the photoconductive drums 22 of the image forming units 21Y, 21M, 21C and 21K with laser light. The optical unit 50 includes, other than not-shown semiconductor laser and modulator, a polygon mirror (not shown) that performs deflection scanning with laser light emitted from the semiconductor laser, a glass window (not shown) for allowing the laser light to pass through, and a frame (not shown) for enclosing each constituent member.

Moreover, the image forming part 20 includes an intermediate transfer unit 30 that performs multi-layer transfer of toner images of respective colors formed on the photoconductive drums 22 of the image forming units 21Y, 21M, 21C and 21K onto an intermediate transfer belt 31, a secondary transfer unit 40 that transfers the toner images superimposed and formed on the intermediate transfer belt 30 onto a sheet P, and a fixing device 45 that heats and pressurizes the toner image formed on the sheet P, to thereby fix the toner image on the sheet P.

The intermediate transfer unit 30 includes the intermediate transfer belt 31, a drive roller 32 that drives the intermediate transfer belt 31, and a tension roller 33 that provides a constant tension to the intermediate transfer belt 31. Moreover, the intermediate transfer unit 30 includes multiple (in the exemplary embodiments, four) primary transfer rollers 34, each of which faces each photoconductive drum 22 with the intermediate transfer belt 31 interposed therebetween, to transfer the toner images formed on the photoconductive drums 22 onto the intermediate transfer belt 31 and a backup roller 35 that faces a secondary transfer roller 41, which will be described later, with the intermediate transfer belt 31 interposed therebetween.

The intermediate transfer belt 31 is extended across multiple rotation members, such as the drive roller 32, the tension roller 33, the multiple primary transfer rollers 34, the backup roller 35 and a driven roller 36. Then, the intermediate transfer belt 31 is driven by the drive roller 32, which is driven and rotated by a drive motor (not shown), to circulate in a direction of arrow at a predetermined speed. As the intermediate transfer belt 31, for example, those formed by rubber or resin are used.

Moreover, the intermediate transfer unit 30 includes a cleaning device 37 that removes residual toner or others existing on the intermediate transfer belt 31. The cleaning device 37 removes the residual toner, paper dust or others from the surface of the intermediate transfer belt 31 after the transfer process of the toner image is finished.

The secondary transfer unit 40 includes the secondary transfer roller 41 provided at a secondary transfer position to press the backup roller 35 with the intermediate transfer belt 31 interposed therebetween, to thereby secondarily transfer an image on the sheet P. The secondary transfer position, where a toner image transferred to the intermediate transfer belt 31 is transferred onto a sheet P, is configured with the secondary transfer roller 41 and the backup roller 35 that faces the secondary transfer roller 41 with the intermediate transfer belt 31 interposed therebetween.

The fixing device 45 fixes an image (toner image) that has been secondarily transferred to the sheet P by the secondary transfer unit 40 onto the sheet P by use of heat and pressure by a heat-fixing roller 46 and a pressure roller 47.

The sheet supply part 60 includes sheet container parts 61 that contain sheets on each of which an image is to be formed, forwarding rolls 62 that forward the sheets P contained in each of the sheet container parts 61, a transport path 63 along which the sheets P forwarded by the forwarding rolls 62 are transported, and transport rolls 64, 65 and 66 that are disposed along the transport path 63 and transport the sheets P forwarded by the forwarding rolls 62 to the secondary transfer position. Moreover, the sheet supply part 60 further includes a manual feed tray 67 capable of supplying sheets P by manual feeding. The manual feed tray 67 can be folded, and is kept folded when not being used, and is unfolded to set the sheets P when being used. In FIGS. 1 and 2, the manual feed tray 67 is shown in the folded state.

The sheet output part 70 is provided at an upper portion of the image forming part 20, and includes a first loading tray 71 that loads the sheets P on each of which an image has been formed by the image forming part 20 and a second loading tray 72 that is provided between the first loading tray 71 and the image reading device 100 and loads the sheets P on each of which an image has been formed by the image forming part 20.

The sheet output part 70 includes transport rolls 75 that are provided downstream of the fixing device 45 in the transport direction and transport the sheet P on which a toner image has been fixed, and a switching gate 76 that is provided downstream of the transport rolls 75 in the transport direction and switches the transport direction of the sheet P. Moreover, the sheet output part 70 includes first output rolls 77 on the downstream side of the switching gate 76 in the transport direction, the first output rolls 77 outputting the sheets P transported in one of the directions (the right side in FIG. 2) switched by the switching gate 76 to the first loading tray 71. Moreover, on the downstream side of the switching gate 76 in the transport direction, the sheet output part 70 includes transport rolls 78 that transport the sheets P transported in the other one of the directions (the upper side in FIG. 2) switched by the switching gate 76 and second output rolls 79 that output the sheets P transported by the transport rolls 78 to a second loading tray 72.

The reverse transport part 80 includes, on the lateral side of the fixing device 45, a reverse transport path 81, along which sheets P that are reversed by rotating the transport rolls 78 in a direction opposite to the direction in which the sheets P are output to the second loading tray 72 are transported. In the reverse transport path 81, multiple transport rolls 82 are provided along the reverse transport path 81. The sheets P transported by the transport rolls 82 are forwarded to the secondary transfer position again.

Moreover, the image recording device 200 includes an apparatus body frame 11 that directly or indirectly supports the image forming part 20, the sheet supply part 60, the sheet output part 70, the reverse transport part 80 and the controller 500, and an apparatus housing 12 that is attached to the apparatus body frame 11 and forms an outer surface of the image forming apparatus 1.

The apparatus body frame 11 includes a reading device support part 13 at one end portion side in the horizontal direction of the image forming apparatus 1, the reading device support part 13 including the switching gate 76, the first output rolls 77, the transport rolls 78, the second output rolls 79 or the like inside thereof and extending in the vertical direction to support the image reading device 100. The reading device support part 13 cooperates with parts at the back side in the apparatus body frame 11, to thereby support the image reading device 100.

Moreover, the image recording device 200 includes, as part of the apparatus housing 12, a front cover 15 that is provided at the frontward side of the image forming part 20 and is attached in an openable and closable manner to the apparatus body frame 11.

A user can replace the intermediate transfer unit 30 or the toner cartridges 29Y, 29M, 29C, 29K in the image forming part 20 with new one by opening the front cover 15.

The user interface 300 is, for example, a touch panel. Therefore, the user interface 300 includes a liquid crystal panel (not shown) for display an image, and also includes a position detection part (not shown) that detects a position where a contact material, which is typified by a finger of a person, contacts when the contact material is in contact with the liquid crystal panel. In the exemplary embodiments, there is no particular limitation to the touch panel, and accordingly, those of various types, such as a resistive type or a capacitive type, can be used.

By adopting a touch panel as the user interface 300, various kinds of information items, such as image forming conditions of the image forming apparatus 1, are displayed on the touch panel. Then, a user touches the touch panel to perform input operation of the image forming conditions or others. In other words, the user interface 300 functions as a display for displaying information related to the image forming apparatus 1, which is the apparatus itself, as an image, and also functions as an operation part that accepts selection operation by the user for selecting an intended function from the displayed image.

The camera 400 takes a photograph of an eye of a user who operates the user interface 300.

The camera 400 includes, for example, an optical system that converges an image of the eye of the user and an image sensor that detects the image converged by the optical system. The optical system is configured with a single lens or by combining multiple lenses. The image sensor is configured by arranging imaging elements, such as CCDs (charge coupled devices) or CMOS (complementary metal oxide semiconductor) elements. The image sensor performs photoelectric conversion of the detected image by pixel units and outputs the converted image as an image signal.

### <Description of Operations of Image Forming Apparatus 1>

The image forming apparatus 1 configured as described above operates as follows.

For example, a user can make a copy of a document by use of the image forming apparatus 1. In other words, a document can be copied by forming an image on a sheet P by the image recording device 200 based on image data of the document read by the image reading device 100. Moreover, a user can perform printing by transmitting a print job to the image forming apparatus 1 from a not-shown personal computer (PC) or the like connected to a communication line. In other words, printing can be performed by receiving a print job via a communication line and forming an image on a sheet P by the image recording device 200 based on image data included in the print job. Further, a user can perform facsimile transmission and reception. In other words, image data of a document read by the image reading device 100 can be transmitted via a communication line. Or, a user can store image data of a document. In other words, image data of a document can be stored inside the image forming apparatus 1 or inside a PC connected to a communication line.

Here, operations of the image forming apparatus 1 will be described in detail by taking a case, in which a user makes a copy or performs printing of a document, as an example.

An image of a document read by the image reading device 100 or image data received from a PC or the like is subjected to predetermined image processing, and image data having been subjected to the image processing is converted into color-material tone data of four colors of yellow (Y), magenta (M), cyan (C) and black (K), to be outputted to the optical unit 50.

In response to the inputted color-material tone data, the optical unit 50 outputs laser light emitted from a semiconductor laser (not shown) to a polygon mirror via an f-θ lens (not shown). In the polygon mirror, the incident laser light is modulated in accordance with tone data of each color and is subjected to deflection scanning, to be applied to the photoconductive drums 22 of the image forming units 21Y, 21M, 21C and 21K via not-shown image-forming lens and multiple mirrors.

In the photoconductive drum 22 in each of the image forming units 21Y, 21M, 21C and 21K, the surface charged by the charger 23 is subjected to scanning exposure, to thereby form an electrostatic latent image. The formed electrostatic latent images are developed as toner images of yellow (Y), magenta (M), cyan (C) and black (K) in the respective image forming units 21Y, 21M, 21C and 21K. The toner images formed on the photoconductive drums 22 of the image forming units 21Y, 21M, 21C and 21K are subjected to multi-layer transfer onto the intermediate transfer belt 31, which is an intermediate transfer body.

On the other hand, in the sheet supply part 60, the forwarding roll 62 rotates with the timing of image formation to pick up a sheet P contained in the sheet container part 61, and the sheet P is transported by the transport rolls 64 and 65 along the transport path 63. Thereafter, transport rolls 66 rotate with the timing of movement of the intermediate transfer belt 31, on which the toner images have been formed, and the sheet P is transported to the secondary transfer position formed by the backup roller 35 and the secondary transfer roller 41. At the secondary transfer position, onto the sheet P transported from below upwards, the toner images of layered four colors are transferred in the slow scan direction by use of a pressure contact force and a predetermined electric field. Then, the sheet P on which the toner images of respective colors are transferred is subjected to a fixing process by heat and pressure in the fixing device 45 and discharged, to be loaded on the first loading tray 71 or the second loading tray 72.

When there is a request of duplex printing, a sheet P, on one surface of which an image has been formed, is transported upside down at the reverse transport part 80 to be forwarded to the secondary transfer position again. Then, at the secondary transfer position, the toner images are transferred onto the other surface of the sheet P, and the transferred images are fixed in the fixing device 45. Thereafter, the sheet P, on both surfaces of which the toner images are formed, is discharged to be loaded on the first loading tray 71 or the second loading tray 72.

Moreover, the user interface 300 operates as follows.

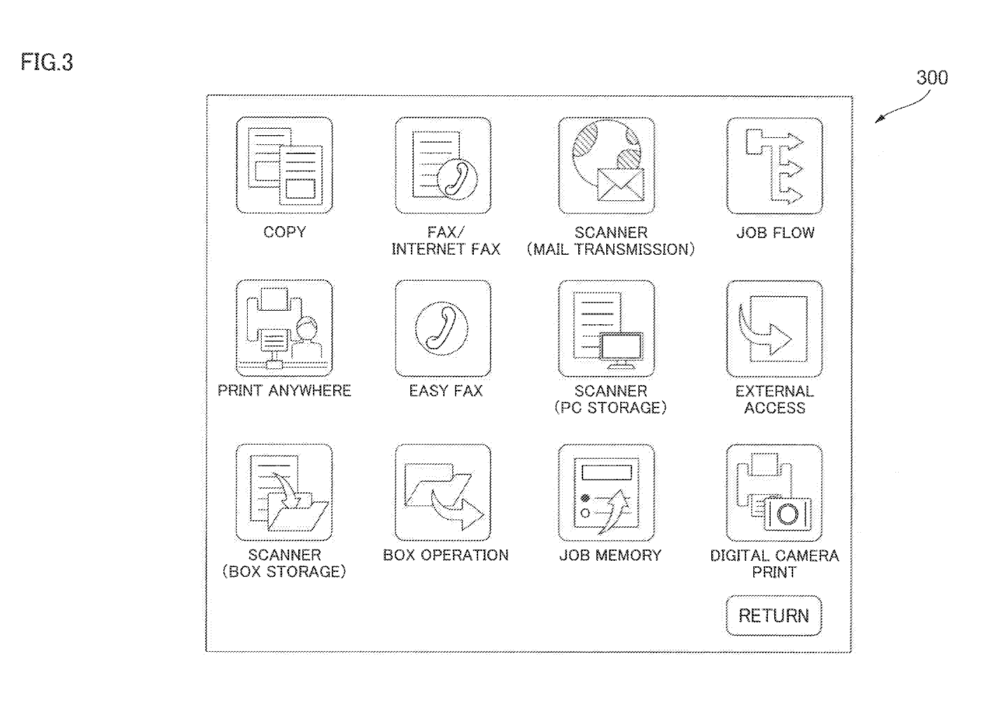

FIG. 3 is a diagram showing an example of an image displayed on the user interface 300.

In this case, on the user interface 300, a list of icons for executing functions included in the image forming apparatus 1 is displayed as an image.

In the specific example shown in the figure, the user interface 300 displays icons indicating functions of: copy; fax/Internet fax; scanner (mail transmission); job flow; print anywhere; easy fax; scanner (PC storage); external access; scanner (box storage); box operation; job memory; digital camera print, as a list.

Moreover, in the specific example shown in the figure, the user interface 300 displays “return” button as a button for screen transition.

Then, a user performs a selection operation to select any of the icons or the button for using an intended function.

The selection operation is, specifically, an operation to touch an icon or a button by a user when the user interface 300 is a touch panel. When a user touches an icon, a setting screen corresponding to a function associated with the icon is displayed. For example, when the icon of “copy” is touched, as a setting screen for performing a copy of a document, a screen for setting a number of copies, selection of a sheet to be used, selection of monochrome/color and scaling is displayed. Then, after the setting, when the user presses a not-shown start button or the like, an actual copy operation is started. Moreover, when the “return” button is touched, it is possible to return to a former screen, such as a home screen.

Moreover, when predetermined conditions are satisfied, the user interface 300 displays a pop-up screen about an item to be displayed on the user interface 300. In this case, the item is, for example, an icon. Then, for example, when a user touches an icon and is still touching for a predetermined time or more (holding down), information about the icon is displayed as a pop-up screen on the user interface 300. The display of the pop-up screen will be described in detail later.

Moreover, the image forming apparatus 1 detects a position of a user's line of sight on the user interface 300 by analyzing an image by the controller 500, the image having been taken by the camera 400. Consequently, for example, based on the detected position of a user's line of sight, it is determined which location on the user interface 300 the user looks at.

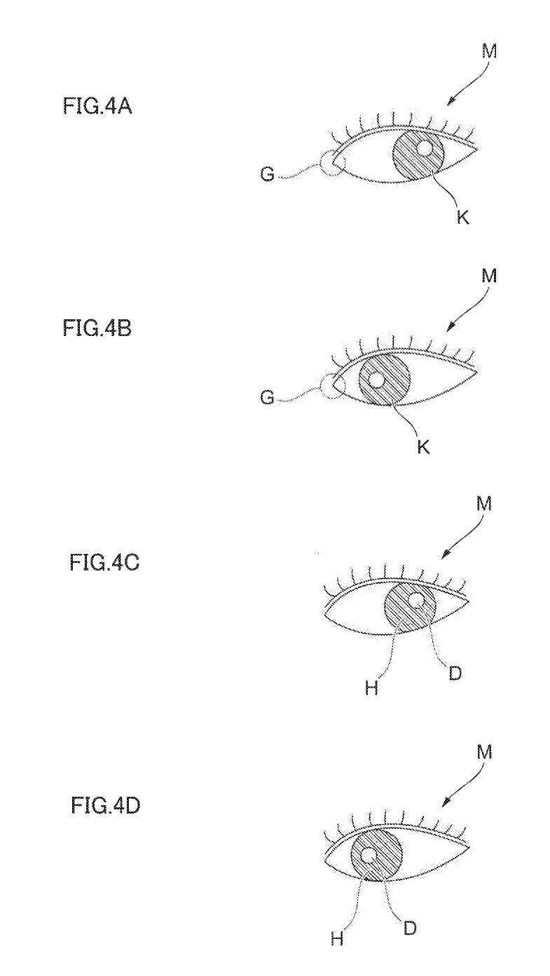

FIGS. 4A to 4D are diagrams illustrating methods of detecting a position of a user's line of sight from an image of user's eye taken by the camera 400.

Of these, FIGS. 4A and 4B show a method of detecting a position of a line of sight by visible light.

In the specific example shown in the figure, first, positions of an inner corner G and an iris K in a user's eye M are obtained. In this case, when a position of a user's line of sight is changed, as shown in FIGS. 4A and 4B, a positional relationship between the inner corner of the eye G and the iris K is changed. As a result, the position of the line of sight can be obtained based on the positional relationship between the inner corner of the eye G and the iris K.

Moreover, FIGS. 4C and 4D show a method of detecting a position of a line of sight by infrared light.

In the specific example shown in the figure, first, positions of a pupil D and corneal reflex H in a user's eye M are obtained. In this case, when a position of a user's line of sight is changed, as shown in FIGS. 4C and 4D, a positional relationship between the pupil D and the corneal reflex H is changed. As a result, the position of the line of sight can be obtained based on the positional relationship between the pupil D and the corneal reflex H.

When the above-described pop-up screen is to be displayed, conventionally, it is common to display the pop-up screen at a fixed position set in advance, the position being adjacent to a location where a user touches. For this reason, fingers or a hand can be positioned on the pop-up screen in some cases. In those cases, the pop-up screen is hidden behind the fingers or hand, and it becomes difficult for the user to visually recognize the pop-up screen. Moreover, depending on height of a user's line of sight, the pop-up screen is displayed at a position less likely to be visually recognized in some cases. Further, the pop-up screen is sometimes displayed at a position for an item to be displayed together with the pop-up screen, and the user cannot visually recognize the necessary item in this case. In other words, since use conditions of a user (positions of fingers, a position of a hand, a posture of a user, an angle of a finger, height of a user's line of sight, information wanted by a user) are different over time, a position where a user can visually recognize with ease is not necessarily constant.

Therefore, in this exemplary embodiment, a position to display the pop-up screen is changed based on a position of a user's line of sight for encouraging the user to visually recognize the pop-up screen, to thereby suppressing occurrence of the above-described problem. Hereinafter, a description will be given of a configuration of the controller 500 for achieving this.

### <Description of Controller 500>

### First Exemplary Embodiment

Next, a first exemplary embodiment of the controller 500 will be described.

In the first exemplary embodiment, a description will be given of a case in which the user interface 300 has a single screen and the position to display the pop-up screen is changed within.

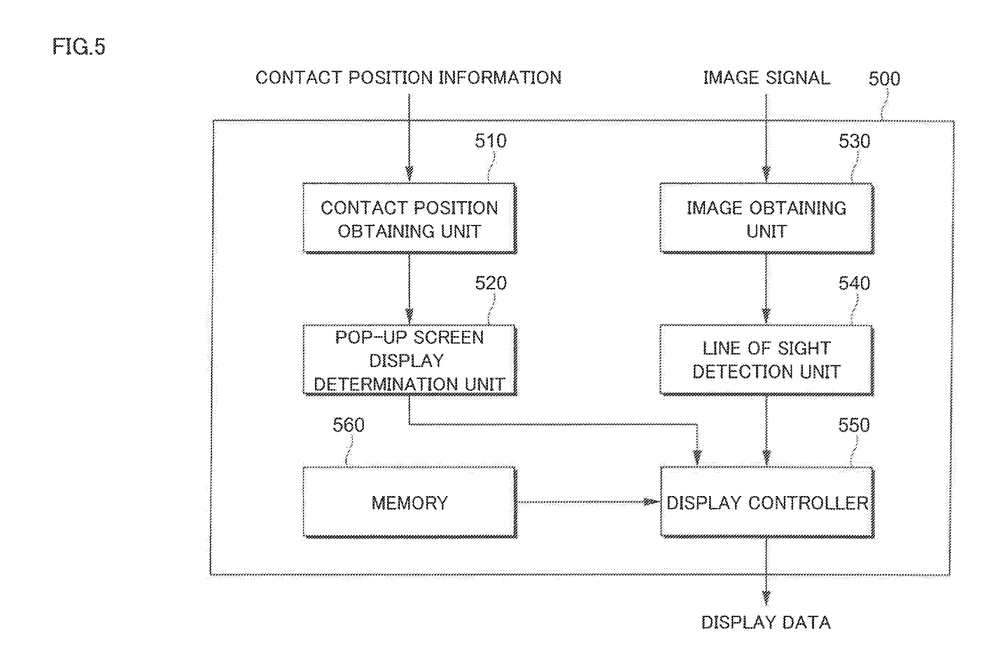

FIG. 5 is a block diagram showing a functional configuration of the controller 500. Note that, in FIG. 5, of the various functions included in the controller 500, those related to the exemplary embodiment are selected and shown.

The controller 500 is an example of an information processing device, and also an example of a display control part that controls display of an image to be displayed on the user interface 300.

As shown in the figure, the controller 500 of the exemplary embodiment includes a contact position obtaining unit 510, a pop-up screen display determination unit 520, an image obtaining unit 530, a line of sight detection unit 540, a display controller 550 and a memory 560.

When a contact material, such as a person's finger, contacts the user interface 300, the contact position obtaining unit 510 obtains a position where the contact material contacts the user interface 300. In other words, as described above, the user interface 300 is a touch panel and a position detection part that detects a position where the contact material contacts the user interface 300 is provided. Therefore, the contact position obtaining unit 510 can obtain the position where the contact material contacts the user interface 300 as contact position information from the position detection part.

The pop-up screen display determination unit 520 determines whether or not the pop-up screen is to be displayed. As described above, for example, the pop-up screen display determination unit 520 determines that the pop-up screen is to be displayed when a user holds down an icon. In this case, a pop-up screen about an item (for example, an icon) displayed at a position where a contact material, such as a person's finger, contacts the user interface 300 is to be displayed. Specifically, display contents of the pop-up screen are, for example, contents of setting of a function displayed as an icon (such as, copy). This allows a user to confirm the setting. Moreover, the display contents of the pop-up screen are, for example, a menu for changing setting of a function displayed as an icon. This allows a user to change the setting. Moreover, the contents of the pop-up screen are, for example, a help screen for a function displayed as an icon. This allows a user to know specific contents or operating methods of things executed by the function.

The image obtaining unit 530 obtains an image signal of an image of a user taken by the camera 400.

The line of sight detection unit 540 determines the positional relationship as described in FIGS. 4A to 4D based on an image of a user taken by the camera 400. Then, the line of sight detection unit 540 detects the position of the user's line of sight on the user interface 300 from the positional relationship.

The display controller 550 displays a pop-up screen about the items (for example, icons) to be displayed on the user interface 300. Further, the display controller 550 controls the display position of the pop-up screen in response to the position of line of sight detected by the line of sight detection unit 540. More specifically, when the pop-up screen display determination unit 520 determines that a pop-up screen is to be displayed, the display controller 550 determines a position to display the pop-up screen on the user interface 300 in response to the position of the user's line of sight on the user interface 300. Then, the display controller 550 obtains the contents of the pop-up screen to be displayed from the memory 560 and performs control to display the pop-up screen on the user interface 300. Therefore, the display controller 550 transmits display data for displaying an icon or a pop-up screen to the user interface 300.

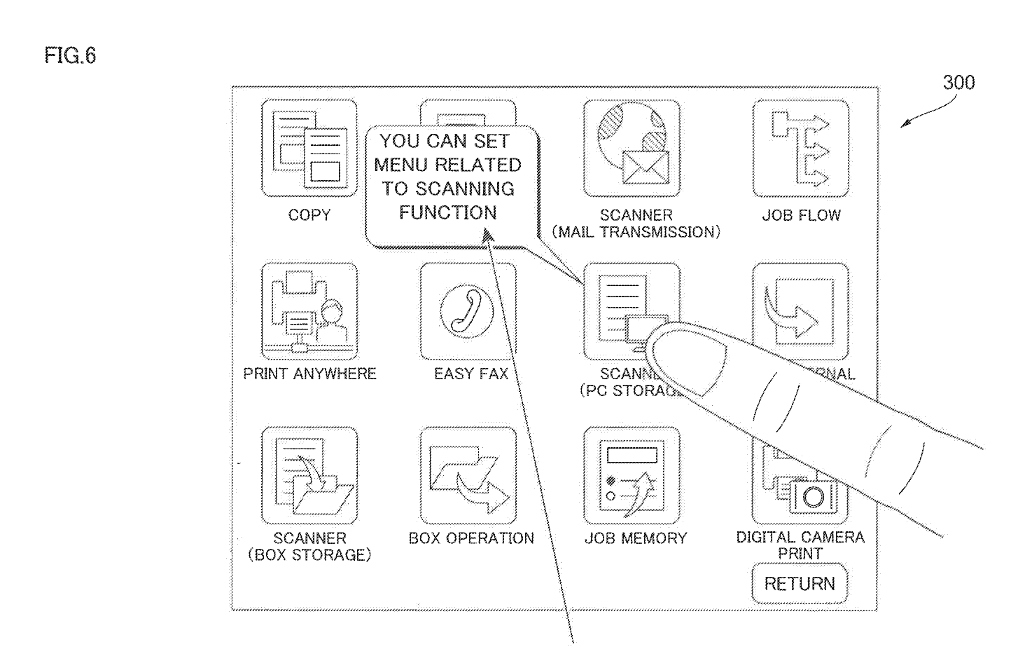

FIG. 6 is a diagram showing a first example of a screen displaying a pop-up screen by the user interface 300 in the first exemplary embodiment.

In the specific example shown in the figure, a user is, for example, holding down the icon of “scanner (PC storage)”, to thereby try to change the setting of the “scanner (PC storage)”. On that occasion, a pop-up screen that shows “You can set menu related to scanning function” is displayed.

An arrow indicates a position of a user's line of sight on the user interface 300 at this time. Then, in this case, the position of the line of sight on the user interface 300 is set as the position to display the pop-up screen. The user directs the position of line of sight at a position easily viewable by him/her, and thereby, the pop-up screen is to be displayed at a position easily viewable. As a result, regardless of the position of user's fingers or hand, it is possible to display the pop-up screen at a position easily viewable by the user. Note that, in the specific example shown in the figure, the position of the line of sight on the user interface 300 is assumed to be the display position of the pop-up screen; however, the display position of the pop-up screen may be set within a predetermined range from the position of line of sight. The predetermined range is, for example, within a range of a circle of 5-cm radius around the position of line of sight.

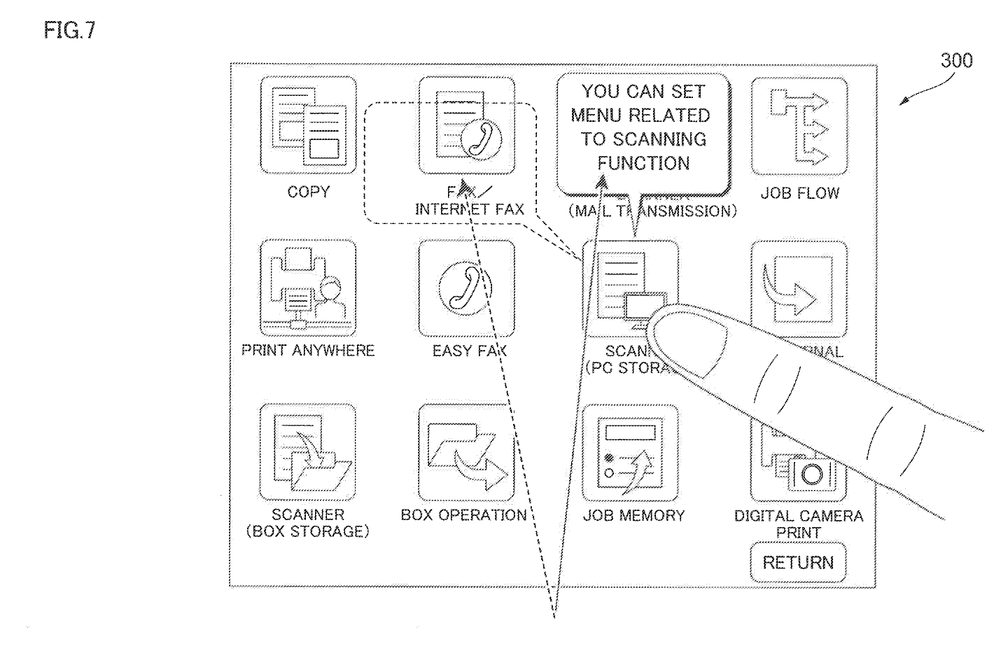

Moreover, FIG. 7 is a diagram showing a second example of the screen displaying the pop-up screen by the user interface 300 in the first exemplary embodiment.

In FIG. 7, as compared to FIG. 6, it is different in that the figure shows a case in which the user's line of sight moves after the pop-up screen is displayed.

In this case, the display controller 550 moves the position to display the pop-up screen in response to movement of the position of the line of sight on the user interface 300. At this time, it may be possible to cause the display position of the pop-up screen to follow immediately after the position of line of sight moves, or it may be possible to move the display position of the pop-up screen when, after the line of sight moves, the user stares at a location, where the line of sight has moved, for a predetermined time or more.

With this configuration, a user can move the position of line of sight at a position easily viewable for him/her, and thereby, a user can display the pop-up screen at a position easily viewable for him/her.

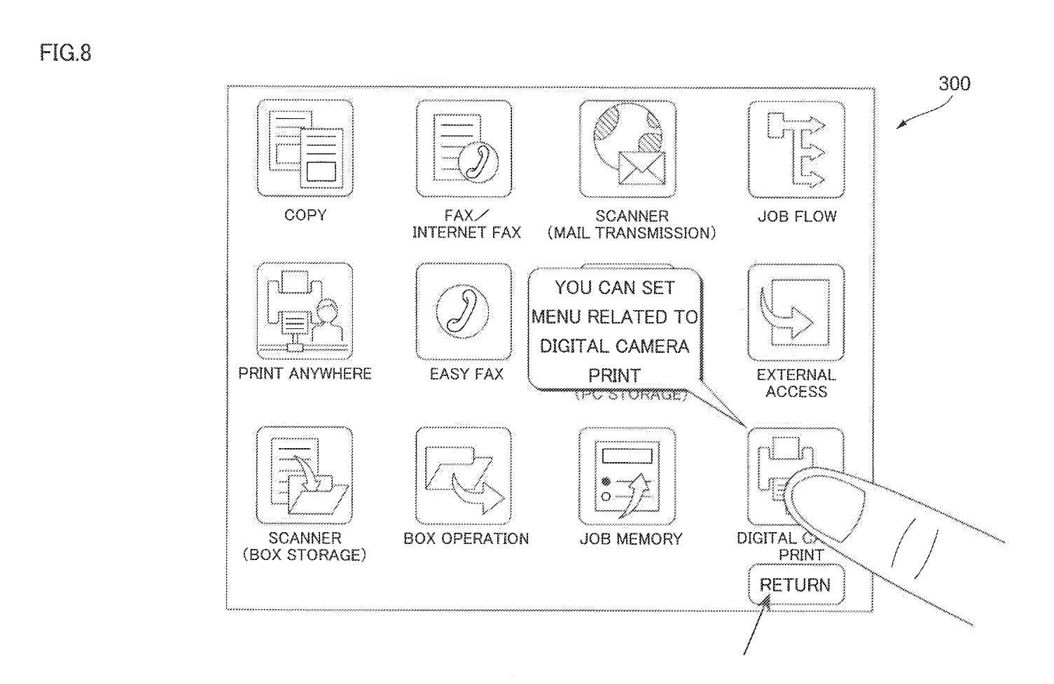

Further, FIG. 8 is a diagram showing a third example of the screen displaying the pop-up screen by the user interface 300 in the first exemplary embodiment.

In FIG. 8, as compared to FIG. 6, it is different in that a user is, for example, holding down the icon of “digital camera print”, to thereby try to change the setting of the “digital camera print”.

In this case, when the position of line of sight is set as the display position of the pop-up screen, the pop-up screen is to be displayed to hide the “return” icon. However, as a result, since the “return” icon is not displayed, convenience for a user is reduced. Therefore, in the exemplary embodiment, when the position of line of sight on the user interface 300 is not suitable as the display position of the pop-up screen, the display controller 550 performs control to change the position to another display position. In FIG. 8, the display position is changed upward of the position of “return” button, where the pop-up screen is to be originally displayed so that the pop-up screen does not hide the “return” icon.

In this manner, as the position not suitable as the display position of the pop-up screen, a position where a button related to screen transition, such as “home” or “start”, and also including “return” is displayed can be provided. Moreover, in addition, a position where a button related to setting operation, such as “cancel” is displayed, or a position where a button related to a pop-up screen to be displayed is displayed can be provided. Further, a position where the settings made until now are displayed is also included.

Moreover, as the position not suitable as the display position of the pop-up screen, a case in which the position of line of sight is at an end portion of the screen of the user interface 300 is also included. In this case, an area necessary for displaying the pop-up screen often cannot be secured. This occurs, for example, in a case where an icon positioned at an end of the user interface 300 is touched or the screen of the user interface 300 is extremely small. In this case, other than changing the display position of the pop-up screen to another position, it can be considered to secure an area necessary for displaying the pop-up screen by scrolling an image displayed on the user interface 300, or to make notification or give warning with sound. Moreover, in a second exemplary embodiment or a third exemplary embodiment to be described later, it can be considered to display the pop-up screen on another screen.

### Second Exemplary Embodiment

Next, a second exemplary embodiment of the controller 500 will be described.

In the second exemplary embodiment, a description will be given of a case in which the user interface 300 includes multiple screens and the position to display the pop-up screen is changed between the multiple user interfaces 300.

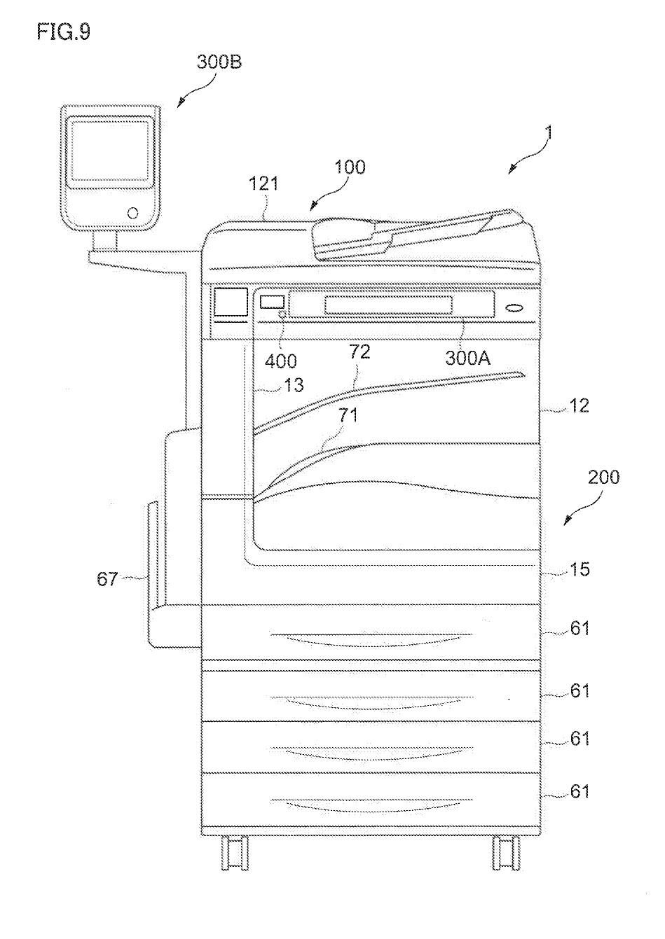

FIG. 9 is a diagram showing an image forming apparatus 1 to which the second exemplary embodiment is applied.

In the image forming apparatus 1 shown in the figure, as compared to the image forming apparatus 1 shown in FIG. 1, the user interface 300 is divided into two. Note that the other components are the same in both figures. Moreover, in FIG. 9, these user interfaces 300 are shown as a user interface 300A and a user interface 300B for distinction.

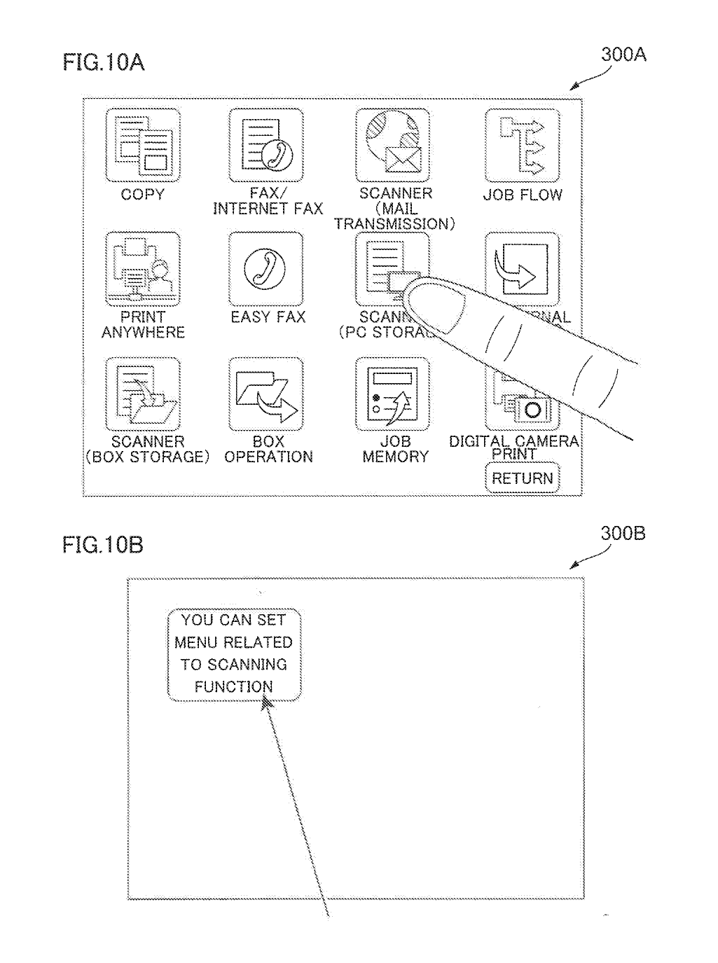

FIGS. 10A and 10B are diagrams showing screens displaying a pop-up screen in the second exemplary embodiment.

Of these, FIG. 10A shows a screen displayed on the user interface 300A. Moreover, FIG. 10B shows a screen displayed on the user interface 300B.

In the specific example shown in the figure, similar to the case in FIG. 6, a user is, for example, holding down the icon of “scanner (PC storage)”, to thereby try to change the setting of the “scanner (PC storage)”. Then, the example also shows that the position of a user's line of sight is on the user interface 300B at this time.

In this case, in the exemplary embodiment, the pop-up screen “You can set menu related to scanning function” is displayed not on the user interface 300A, but on the user interface 300B. In other words, here, there exist multiple user interfaces 300, and the display controller 550 displays the pop-up screen on one of the multiple user interfaces 300 that is at a position of a user's line of sight.

This makes it possible to display the pop-up screen at a position easily viewable by the user.

### Third Exemplary Embodiment

Next, a third exemplary embodiment of the controller 500 will be described.

In the third exemplary embodiment, a description will be given of a case in which, other than the user interface 300, a user has a terminal device and a position to display the pop-up screen is changed to the terminal device.

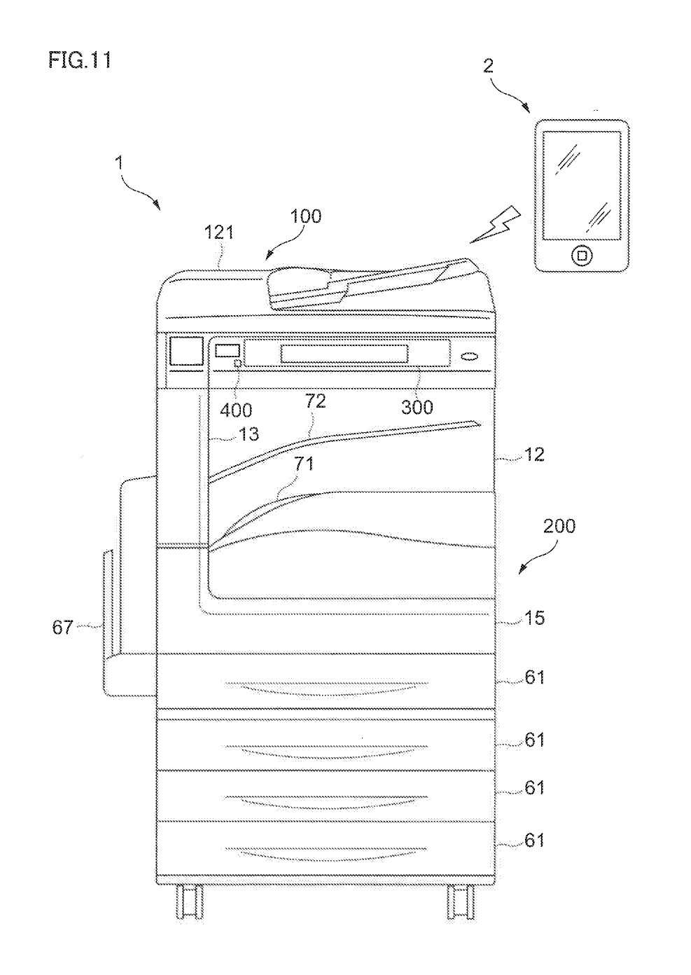

FIG. 11 is a diagram showing an image forming apparatus 1 to which the third exemplary embodiment is applied.

FIG. 11 shows, other than the image forming apparatus 1, a terminal device 2 held by a user. The terminal device 2 is an example of an external device, which is, for example, a mobile terminal, such as a mobile phone, a smartphone, a tablet or a personal computer (PC). Similar to the user interface 300, the terminal device 2 includes a display and has a function of displaying an image.

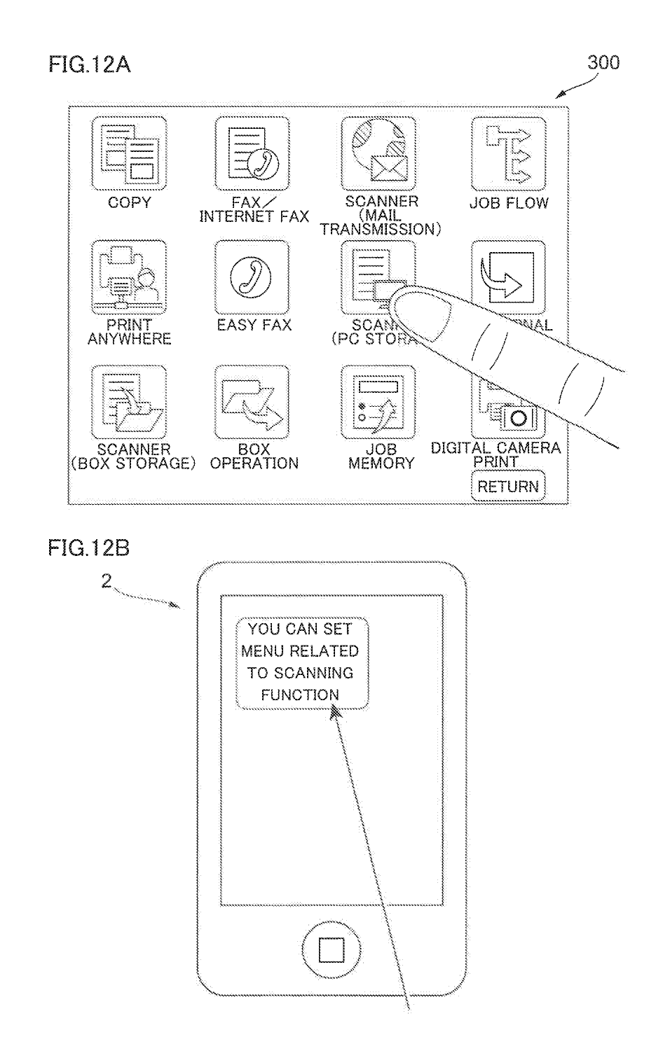

FIGS. 12A and 12B are diagrams showing screens displaying a pop-up screen in the third exemplary embodiment.

Of these, FIG. 12A shows a screen displayed on the user interface 300. Moreover, FIG. 12B shows a screen displayed on the terminal device 2.

In the specific example shown in the figure, similar to the case in FIG. 6, a user is, for example, holding down the icon of “scanner (PC storage)”, to thereby try to change the setting of the “scanner (PC storage)”. Then, the example also shows that the position of a user's line of sight is on the terminal device 2 at this time.

In this case, in the exemplary embodiment, the pop-up screen “You can set menu related to scanning function” is displayed not on the user interface 300, but on the terminal device 2. Note that the exemplary embodiment is not limited to the case in which the user's line of sight is on the terminal device 2; the pop-up screen may be displayed on the terminal device 2 when the user's line of sight is out of the user interface 300. In other words, the display controller 550 displays the pop-up screen on the external device (terminal device 2) when the line of sight is out of the range of the user interface 300.

In this case, also, it is possible to display the pop-up screen at a position easily viewable by the user.

### <Description of Operations of Controller 500>

Next, operations of the controller 500 will be described.

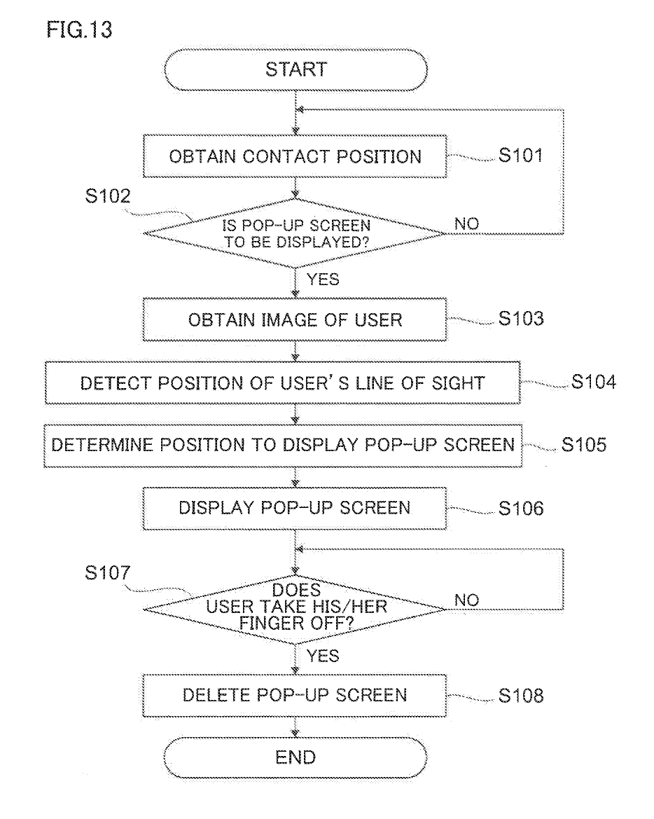

FIG. 13 is a flowchart illustrating operations of the controller 500.

First, when a person's finger contacts the user interface 300, the contact position obtaining unit 510 obtains a position where the finger contacts the user interface 300 (step 101).

Next, the pop-up screen display determination unit 520 determines whether or not the pop-up screen is to be displayed (step 102). This can be determined based on, for example, whether or not a user holds down an icon.

When the pop-up screen display determination unit 520 determines that the pop-up screen is not to be displayed (No in step 102), the process returns to step 101.

In contrast, when the pop-up screen display determination unit 520 determines that the pop-up screen is to be displayed (Yes in step 102), the image obtaining unit 530 obtains an image of a user taken by the camera 400 (step 103).

Next, the line of sight detection unit 540 detects a position of the user's line of sight on the user interface 300 based on the image of the user taken by the camera 400 (step 104).

Then, the display controller 550 determines a position to display the pop-up screen on the user interface 300 (step 105). Further, the display controller 550 obtains contents of the pop-up screen to be displayed from the memory 560 and displays the pop-up screen on the user interface 300 (step 106). At this time, in the first exemplary embodiment, the pop-up screen is displayed at the position of the line of sight on the user interface 300. Moreover, in the second exemplary embodiment, the pop-up screen is displayed at the position of the line of sight on the user interface 300B. Further, in the third exemplary embodiment, the pop-up screen is displayed on the display of the terminal device 2.

Next, the pop-up screen display determination unit 520 determines whether or not the user takes his/her finger off the icon (step 107).

When the pop-up screen display determination unit 520 determines that the user does not take his/her finger off the icon (No in step 107), the process returns to step 107.

In contrast, when the pop-up screen display determination unit 520 determines that the user has taken his/her finger off the icon (Yes in step 107), the display controller 550 deletes the pop-up screen from the user interface 300 (step 108).

Note that, in the above-described examples, after the pop-up screen display determination unit 520 determines that the pop-up screen is to be displayed, the position of the user's line of sight is detected; however, the exemplary embodiments are not limited thereto, and the position of the user's line of sight may be detected at first.

Moreover, in the specific example described above, the pop-up screen is displayed by user's holding down of the icon as a trigger; however, the exemplary embodiments are not limited thereto. For example, a user's “hesitation”, such that a user does nothing for a predetermined time, is detected and the pop-up screen may be displayed based on the fact as a trigger.

Further, in the above-described example, the display controller 550 deletes the pop-up screen from the user interface 300 by user's taking his/her finger off the icon as a trigger; however, the exemplary embodiments are not limited thereto. For example, the position of the user's line of sight moves away off the user interface 300 and the user looks at something other than the user interface 300, the pop-up screen may be deleted from the user interface 300. Moreover, when the user's “hesitation” is detected to trigger the display of the pop-up screen, the pop-up screen may be deleted from the user interface 300 triggered by “Clearance of hesitation”, such that the user does some sort of operation. Further, a cancel button is provided while the pop-up screen is displayed, and the pop-up screen may be deleted from the user interface 300 when the user touches the cancel button.

Note that, in the above-described example, the description has been given by taking the image forming apparatus 1; however, the present invention is not limited thereto. In other words, the exemplary embodiments are applicable if an apparatus receives inputs or the like by touching a display and has a function of displaying a pop-up screen on the display. For example, the exemplary embodiments are applicable to appliances, such as a mobile phone, a smartphone and a tablet, that display icons of application software arranged in line.

Note that the processing executed by the controller 500 is implemented by cooperation of software and hardware resources.

Consequently, the processing executed by the controller 500 can be recognized as an information processing method, and also, as a non-transitory computer readable medium storing a program that causes a computer to execute: a line of sight detection function that detects a position of a user's line of sight on the user interface 300 for displaying an image; and a display control function that displays a pop-up screen about an item to be displayed on the user interface 300 and controls a display position of the pop-up screen in response to the position of the line of sight.

The foregoing description of the present exemplary embodiments of the present invention has been provided for the purposes of illustration and description. It is not intended to be exhaustive or to limit the invention to the precise forms disclosed. Obviously, many modifications and variations will be apparent to practitioners skilled in the art. The present exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a line of sight detection unit that detects a position of a user's line of sight on a display to display an image; and
a display controller that displays a pop-up screen about an item to be displayed on the display and controls a display position of the pop-up screen in response to the position of line of sight detected by the line of sight detection unit.

2. The information processing device according to claim 1, wherein the display controller sets the position of line of sight on the display or an inside of a range that is predetermined based on the position of line of sight as the display position of the pop-up screen.

3. The information processing device according to claim 1, wherein the display controller moves the display position of the pop-up screen in response to movement of the position of line of sight on the display.

4. The information processing device according to claim 1, wherein, when the position of line of sight on the display is not suitable as the display position of the pop-up screen, the display controller performs control to change the display position to another display position.

5. The information processing device according to claim 1, wherein
the information processing device comprises a plurality of the displays, and
the display controller displays the pop-up screen on one of the plurality of the displays that is at a position of the user's line of sight.

6. The information processing device according to claim 1, wherein the display controller displays the pop-up screen on an external device when the position of line of sight is out of a range of the display.

7. The information processing device according to claim 1, further comprising:
a contact position obtaining unit that detects, when a contact material contacts the display, a position where the contact material contacts the display, wherein
the display controller displays the pop-up screen about the item displayed at the position where the contact material contacts the display.

8. An image forming apparatus comprising:
an image forming part that forms an image on a recording material;
a display that display information related to the apparatus as an image; and
a display control part that controls display of an image to be displayed on the display, wherein
the display control part comprises:
a line of sight detection unit that detects a position of a user's line of sight on the display; and
a display controller that displays a pop-up screen about an item to be displayed on the display and controls a display position of the pop-up screen in response to the position of line of sight detected by the line of sight detection unit.

9. A non-transitory computer readable medium storing a program that causes a computer to execute functions, the functions comprising:
detecting a position of a user's line of sight on a display to display an image; and
displaying a pop-up screen about an item to be displayed on the display and controlling a display position of the pop-up screen in response to the detected position of line of sight.
